(19) United States
(12) Patent Application Publication
(10) Pub. No.: US 2026/0274206 A1
(43) Pub. Date: Sep. 17, 2026

(54) Method and Apparatus for Generating Key Generation Information for a Digital Access Key for a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/565,715

(22) Filed: Mar. 13, 2026

(30) Foreign Application Priority Data
Mar. 14, 2025 (DE) 10 2025 109 976.6

(51) Int. Cl. B60R 25/24; G07C 9/00; H04L 9/40

(52) U.S. Cl. CPC B60R 25/241; G07C 9/00309; H04L 63/0442; H04L 63/0823; G07C 2009/00793

(57) ABSTRACT

An apparatus and a method for generating key generation information for a digital access key for a motor vehicle provide a service request from the user terminal to a remote computing device to generate a digital access key for the motor vehicle for a predetermined service in the motor vehicle. The service request includes a service identifier that identifies a service with respect to the motor vehicle and a user of the user terminal. The apparatus and method check the service request in the remote computing device, generate key generation information in the remote computing device in response to the service request, and provide the key generation information to the user terminal.

### CROSS REFERENCE TO RELATED APPLICATION

This application claims priority under 35 U.S.C. §119 from German Patent Application No. 10 2025 109 976.6, filed Mar. 14, 2025, the entire disclosure of which is herein expressly incorporated by reference.

### BACKGROUND AND SUMMARY

The invention relates to a method and an apparatus for generating key generation information for a digital access key for a motor vehicle.

Document DE 10 2015 223 342 A1, for example, specifies a method for operating an authorization apparatus for a vehicle, which authorization apparatus is designed for initial communication with the vehicle.

The object of the invention is to specify an improved method and an improved apparatus for generating key generation information for a digital access key for a motor vehicle.

This object is achieved in accordance with the invention by the subjects of the independent patent claims. The dependent patent claims and the description relate to advantageous embodiments of the invention.

According to a first aspect, a method for generating key generation information for a digital access key for a motor vehicle is specified.

The method according to the invention comprises the steps of providing a service request from a user terminal to a remote computing device in order to generate a digital access key for the motor vehicle for a predetermined service in the motor vehicle, the service request comprising a service identifier that identifies a service with respect to the motor vehicle and a user of the user terminal, checking the service request in the remote computing device, generating key generation information in the remote computing device in response to the checking, providing the key generation information to the user terminal, and generating a digital access key in the user terminal for the motor vehicle for the predetermined service in the motor vehicle based on the key generation information.

The method according to the invention is used in particular to enable one or more user terminals for a particular service, which is carried out or is intended to be carried out in the motor vehicle, for example a workshop visit, and to provide this user terminal with generation information for a (further) digital access key for the performance of this service or to have this generation information provided in particular by a remote computing device. In particular, a certain degree of security is provided by the method according to the invention, in particular through the use of a service identifier.

A user terminal, which can also be referred to as a user device, is a device or an apparatus designed to receive operator control inputs, user inputs and/or user commands and to communicate with a motor vehicle in order, in particular, to provide these operator control inputs to the motor vehicle and thereby trigger functions in the motor vehicle.

In particular, the user terminal is a portable or mobile device which is different from the motor vehicle and which can be designed, in particular, as a so-called smart device, that is to say as an apparatus having at least one processor device, for example, a smartphone, a phablet or a tablet, a smart watch, smart glasses and/or a wearable, which also provides other functions, such as making calls, surfing the Internet or messaging services, for example, through applications or programs.

In particular, the user terminal is designed to trigger or perform one or more functions in relation to one or more motor vehicles, such as locking and/or unlocking one or more flaps, such as doors, and in particular also actively opening and/or closing one or more of such flaps, as well as releasing an immobilizer, starting an engine and/or moving the motor vehicle.

Such functions or interactions with the motor vehicle, in particular those enabling access or flap control and/or movement of the motor vehicle, can also be referred to as secure and/or protected functions and are supported in or by the user terminal or are implemented therein, in particular by means of a secure element, which can also be referred to as a secure module. Such a secure element may contain both hardware components, for example, in the form of a secure processor and/or a secure storage area, and software components, for example, one or more apps, applications or programs, which interact.

In order to trigger such functions, the user terminal typically has at least one digital access key and/or this is generated during this method. In particular, such a digital access key may be based on an asymmetric cryptosystem and/or may use such a system, wherein both the motor vehicle and the user terminal have a private key and a public key which are designed to authorize or to legitimize one another.

For this purpose, the user terminal communicates with a remote computing device in order to carry out the method. Such a remote computing device or vehicle computing device is different, separate and at a distance from the motor vehicle and the user terminal. The remote vehicle computing device may include one or more servers which may also be partially or completely organized in the cloud. The remote vehicle computing device can be operated, in particular, by a manufacturer of the motor vehicle and can be used, in particular exclusively, to manage such services and/or digital access keys for one or more motor vehicles.

The communication between the user terminal and the remote computing device and between the remote computing device and the motor vehicle can be carried out, in particular, via one or more wireless communication protocols or standards, in particular far-field communication protocols, such as one or more of WLAN or WIFI, satellite communication, in particular Iridium, Orbcomm and/or Thuraya, and/or mobile radio, in particular 3G, 4G, 5G, etc.

Communication between the user terminal and the motor vehicle is not provided for carrying out the method in the present case, but can take place before and/or after carrying out the method, for example, when performing a function of the motor vehicle using the user terminal.

In order to carry out the method, a service request is provided from the user terminal to the remote computing device in a first step in order to generate a digital access key for the motor vehicle for a predetermined service in the motor vehicle, the service request comprising a service identifier that identifies a service with respect to the motor vehicle and a user of the user terminal.

The purpose of the service request is to generate a second or further, access key for the motor vehicle, which is used, exclusively, to carry out at least one predetermined service in the motor vehicle, such as a workshop visit.

To this end, the service request also includes a service identifier that identifies a service with respect to the motor vehicle and a user of the user terminal. The service identifier, which can also be referred to as a service token, thus serves to uniquely assign the user of the user terminal to the service and the motor vehicle. The service request may also contain further information, such as service identification information that uniquely identifies the service from multiple services. In particular, the user, who can be uniquely identified, for example, via a user account, was previously activated or enabled for the motor vehicle and for this particular service.

The service request is then checked in the remote computing device, for example as part of a plausibility check. In particular, the service identifier can also be checked in the remote computing device, for example, in order to determine whether it is valid or exists, for the user of the user terminal. For this purpose, the service identifier may have previously been provided to the remote computing device, for example likewise during activation or enabling.

In a further step, solely if the checking of the service request or the service identifier was successful, key generation information is generated in the remote computing device in response to the checking.

In a further step, this generated key generation information is provided back to the user terminal.

In a further step, the digital access key is then generated in the user terminal for the motor vehicle for the predetermined service in the motor vehicle based on the key generation information.

The method according to the invention makes it possible to enable one or more user terminals for a particular service, which is carried out or is intended to be carried out in the motor vehicle, for example a workshop visit, and to provide this user terminal with generation information for a (further) digital access key for the performance of this service or to have this generation information provided by a remote computing device. A certain degree of security is provided by the method according to the invention, in particular through the use of a service identifier.

According to one development, the method further comprises the steps of generating generation request parameters comprising the service identifier in the remote computing device in response to the checking of the service request, providing the generation request parameters from the remote computing device to the user terminal, signing the generation request parameters in the user terminal, providing the signed generation request parameters from the user terminal to the remote computing device, and checking the signed generation request parameters in the remote computing device, wherein key generation information is generated in the remote computing device in response to the checking of the signed generation request parameters.

Thus, in a further step, generation request parameters comprising the service identifier are generated in the remote computing device in response to the checking of the service request or the service identifier, exclusively if this checking was successful. These generation request parameters may also include further information, such as session identification information and the service identification information, as well as further data, with respect to the user.

In a further step, these generated generation request parameters are provided from the remote computing device back to the user terminal. These generation request parameters are further processed and signed there.

In a further step, the signed generation request parameters are provided from the user terminal to the remote computing device, where they are checked. The newly added signature and optionally also the session are then checked here.

This development enables particularly secure key generation.

According to one development, the step of generating a digital access key in the user terminal comprises the steps of generating an endpoint certificate comprising the service identifier in the user terminal, providing the endpoint certificate to the remote computing device, checking the validity of the service identifier in the remote computing device, and providing confirmation information for the digital access key to the user terminal and the motor vehicle in response to the checking.

The step of generating the key generation information is thus divided into a plurality of sub-steps which are described below and can be carried out both in place of generating the key generation information and in addition to it.

An endpoint certificate is first generated in the user terminal. An endpoint certificate is a certificate that creates or enables an endpoint of a certificate chain, which extends from a root, a root certificate, via one or more intermediate certificates to the endpoint, thereby creating or enabling a chain of trust. The endpoint certificate comprises the service identifier or includes it in its additional data or extension data.

This endpoint certificate with the service identifier is then provided to the remote computing device and the validity of the service identifier is checked there.

Only if the checking is successful, confirmation information for the digital access key is provided from the remote computing device to the user terminal and the motor vehicle. This confirmation information can also be referred to as an attestation.

This development enables particularly secure key generation.

According to one development, the key generation information comprises a reference to an Internet resource, wherein the step of generating the digital access key in the user terminal comprises calling the Internet resource.

A reference to an Internet resource is, for example, a link, in particular a hyperlink, and/or a URL, or Uniform Resource Locator. In particular, the reference may also include the service identification information. In order to generate the digital access key, this reference can then be called or the call replaces or at least comprises the step of generating the digital access key.

This development enables particularly secure key generation.

According to one development, the step of generating an endpoint certificate is carried out in response to calling the Internet resource.

Therefore, the endpoint certificate is generated in the user terminal only after calling the Internet resource, in particular using the service identification information included in the reference.

This development enables particularly secure key generation.

According to one development, the generation request parameters are signed in a secure element of the user terminal.

The user terminal may comprise, as previously described, a secure element which may also be designed to make a signature. This is carried out according to this development such that the secure element signs the generation request parameters.

Alternatively, the generation request parameters are signed in an operating system of the user device. In other words, the generation request parameters are alternatively not signed in a secure element. This can be carried out on the one hand because the user terminal does not have a secure element, and on the other hand because the user of the user terminal is not an owner for whom a possible signing key is not present in a secure element.

This development enables particularly secure key generation.

According to one development, the endpoint certificate is generated in a secure element of the user terminal.

In particular, the endpoint certificate is issued in the previously described secure element of the user terminal.

This development enables particularly secure key generation.

According to a further aspect, an apparatus for generating key generation information for a digital access key for a motor vehicle is specified.

The apparatus comprises means for carrying out one or more embodiments of the method described above. In particular, the apparatus comprises one or more processor devices to carry out the method described above. In particular, the apparatus also comprises a memory in which code is stored, in particular in a non-volatile manner, which, when executed by a processor device, causes this to carry out the method described above.

In particular, the apparatus may comprise a user terminal, a further, second user terminal and/or one or more further remote computing devices or may form a system therewith in order to carry out or at least effect the method described above. The apparatus may also comprise one or more motor vehicles and/or a motor vehicle fleet comprising a plurality of motor vehicles or may form a system therewith. In particular, the apparatus may comprise any equipment and/or any device as described above or may form a system therewith.

Further features of the invention emerge from the claims, the figures and the description of the figures. The features and combinations of features mentioned above in the description, and the features and combinations of features mentioned below in the description of the figures and/or shown in the figures alone can be used not only in the respectively specified combination but also in other combinations or on their own.

The invention will now be explained in more detail on the basis of one preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of one embodiment of an apparatus and a method for generating key generation information for a digital access key for a motor vehicle;

FIG. 2 shows a schematic flowchart of one embodiment of an apparatus and a method for generating key generation information for a digital access key for a motor vehicle;

FIG. 3 shows a schematic flowchart of a further embodiment of an apparatus and a method for generating key generation information for a digital access key for a motor vehicle;

FIG. 4 shows a schematic flowchart of a further embodiment of an apparatus and a method for generating key generation information for a digital access key for a motor vehicle; and

FIG. 5 shows a schematic flowchart of a further embodiment of an apparatus and a method for generating key generation information for a digital access key for a motor vehicle.

### DETAILED DESCRIPTION OF THE DRAWINGS

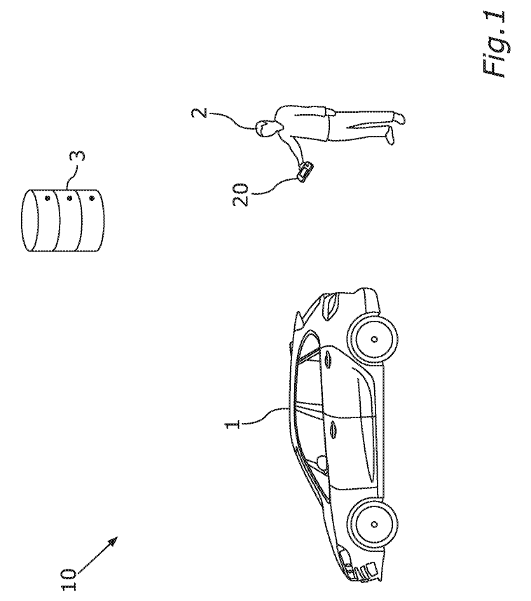

FIG. 1 shows a schematic perspective view of one embodiment of a method and an apparatus 10 for generating key generation information for a digital access key for a motor vehicle 1.

The apparatus comprises the user terminal 20 of a user 2 and a remote computing device 3. The apparatus 10 is designed to perform or at least effect the method steps described below.

The apparatus 10 is designed to provide a service request from the user terminal 20 to the remote computing device 3 in order to generate a digital access key for the motor vehicle 1 for a predetermined service in the motor vehicle, the service request comprising a service identifier that identifies a service with respect to the motor vehicle 1 and the user 2 of the user terminal 20.

The apparatus 10 is also designed to generate generation request parameters comprising the service identifier in the remote computing device 3.

The apparatus 10 is also designed to provide the generation request parameters from the remote computing apparatus 3 to the user terminal 20.

The apparatus 10 is also designed to sign the generation request parameters in the user terminal.

The apparatus 10 is also designed to provide the signed generation request parameters from the user terminal 20 to the remote computing device 3.

The apparatus 10 is also designed to check the signed generation request parameters in the remote computing device 3.

The apparatus 10 is also designed to generate key generation information in the remote computing device 3 in response to the checking.

The apparatus 10 is also designed to provide the key generation information to the user terminal 20.

The apparatus 10 is also designed to generate a digital access key in the user terminal 20 for the motor vehicle 1 for the predetermined service in the motor vehicle based on the key generation information.

The apparatus 10 is also designed to generate an endpoint certificate comprising the service identifier in the user terminal 20.

The apparatus 10 is also designed to provide the endpoint certificate to the remote computing device 3.

The apparatus 10 is also designed to check the validity of the service identifier in the remote computing device 3.

The apparatus 10 is also designed to provide confirmation information for the digital access key to the user terminal 20 and the motor vehicle 1 in response to the checking.

The key generation information may include a reference to an Internet resource, wherein the apparatus is designed to call the Internet resource.

The apparatus 10 is also designed to generate the endpoint certificate in response to calling the Internet resource.

The apparatus 10 is also designed to generate the generation request parameters in a secure element of the user terminal. Alternatively, the apparatus 10 is designed to sign the generation request parameters in an operating system of the user device.

The apparatus 10 is also designed to sign the generation request parameters in a secure element of the user terminal.

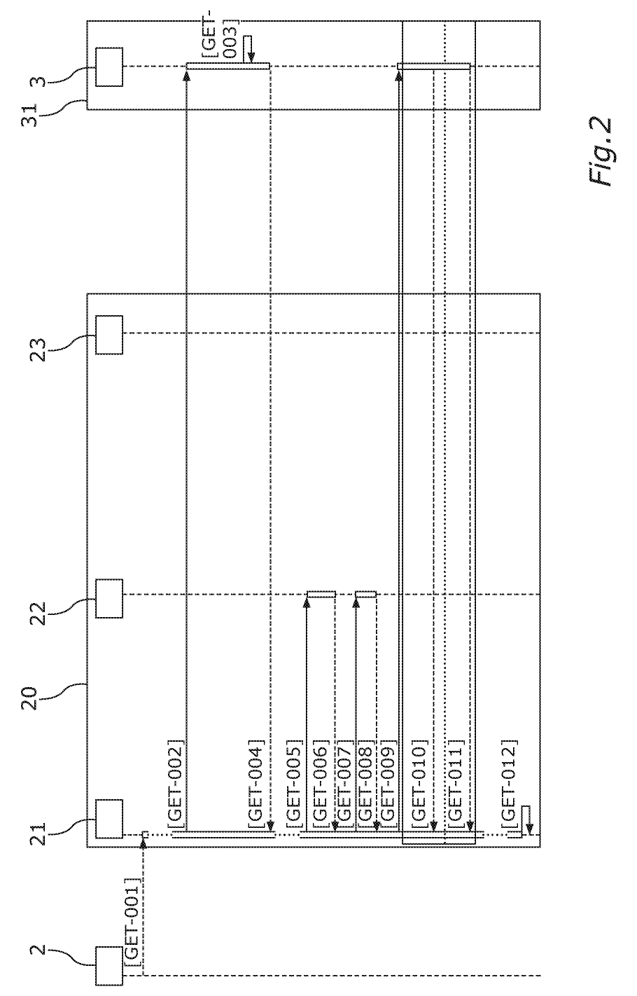

Detailed method steps as described in connection with this FIG. 1 are now explained with reference to FIGS. 2-5. In particular, the interaction of the user 2 with the user terminal 20 and of the user terminal 20 with the remote computing device 3 is described therein. The user terminal 20 has an application 21 which is also designed to receive user inputs and to provide outputs to the user 2. The user terminal 20 also has an operating system 22 on which the application is operated. The user terminal further has a secure element 23 which interacts with the operating system 22 and is responsible for the management by means of a signature. The remote computing device has a key-sharing service module 31 which is responsible for the interaction with the user terminal 20 and manages the services. The remote computing device 3 can also be referred to as a backend.

FIG. 2 shows a schematic flowchart of one embodiment of a method for generating key generation information for a digital access key for a motor vehicle 1, as shown in FIG. 1.

In these first steps GET-001 to GET-010, the service information is created and retrieved or provided. In the first four steps GET-001 to GET-004, the basic service information is retrieved, in the further five steps GET-005 to GET-009, a status of a coupling or bond for the service is retrieved and, in the last step GET-010, the retrieved service information is output on the user terminal 20.

In a first step GET-001, a user request from the user 2, which includes a request to display service details for a particular service, is received in the user terminal 20 in the application 21.

In a further step GET-002, this request from the user is provided to the remote computing device 3 and its key-sharing service module 31. This request also includes service identification information.

In a further step GET-003, this request is processed in the remote computing device 3 and service details are compiled within this framework. These service details may also be referred to figuratively as a service card and include the service identification information, a name, a description of the service, and certain service options. For example, these service options may include a time frame such as a time limit and/or a local restriction of the service.

In a further step GET-004, the service details are provided from the key-sharing service module 31 back to the application 21 of the user terminal 20.

In a further step GET-005, the application 21 requests a service identifier from the operating system 22 and, in a further step GET-006, this service identifier is provided from the operating system 22 to the application 21. This service identifier is designed to uniquely identify a service with respect to the motor vehicle 1 and the user 2.

In a further step GET-007, service details are again requested from the key-sharing service module 31. This request includes the service identification information and the service identifier.

In a further step GET-008, the request is verified in the key-sharing service module 31 and a coupling status for the service identifier is checked.

In a further step GET-009, the coupling status is returned to the application 21.

In a further step GET-010, the service details or the service card and the coupling status are then provided or displayed for the user 2 in the application 21.

This completes the section of retrieving the service information.

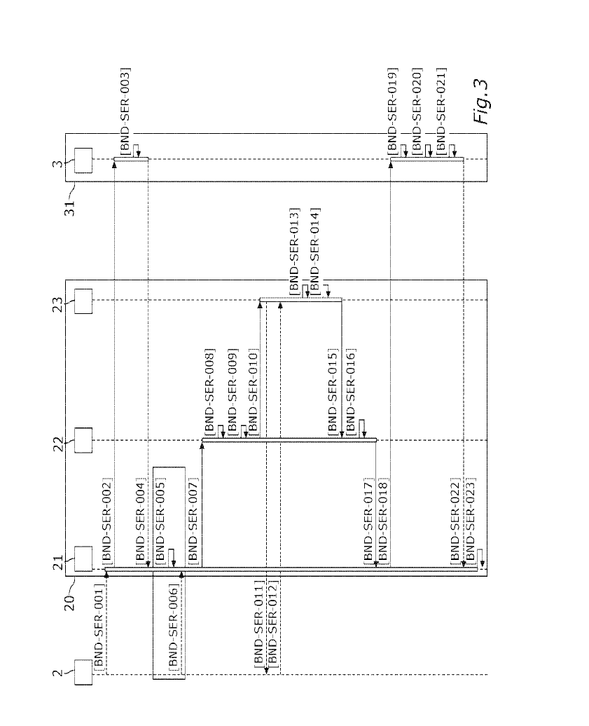

FIG. 3 shows a further flowchart of one exemplary embodiment of a method for generating key generation information for a digital access key for a motor vehicle 1. These steps shown in this FIG. 3 follow the steps shown above in FIG. 2 or the steps according to FIG. 2 have been successfully run through at least once before. The steps shown here in FIG. 3 relate to the activation of a service taking into account the previously performed request.

In a first step ACT-001 of the method section shown here, a user request by the user 2 is provided to the application 21 in order to activate a service.

In a further step ACT-002, in response, a service activation request is provided from the application 21 to the key-sharing service module 31 together with service identification information and further parameters which are also taken from the user request or can be based on it.

In a further step ACT-003, secure signing data are compiled in the key-sharing service module 31 for the requested activation. These signing data include actions to be taken, such as the activation of the service and associated parameters and information.

In a further step ACT-004, these previously compiled secure signing data are provided from the remote computing device 3 to the user terminal 20 and are processed and in particular stored in the application 21 there.

In a further step ACT-005, service activation details are displayed in the application 21 on the user terminal 20 for the user 2 and, in a further step ACT-006, a user input that confirms or enables the activation of the service is received from the user 2.

These two steps ACT-005 and ACT-006 are optional and it is also possible to continue with the following step ACT-007 immediately after step ACT-004.

In a further step ACT-007, a request to sign a service management request is provided from the application 21 to the operating system 22.

In a further step ACT-008, a service identifier is calculated by the operating system 22.

In a further step ACT-009, service management request data are compiled from the secure signing data and the service identifier.

In a further step ACT-010, a request to sign the previously compiled service management request data is provided from the operating system 22 to the secure element 23.

In a further step ACT-011, a request to be authenticated is provided from the secure element 23 to the user 2.

In a further step ACT-012, a user input that successfully authenticates the user 2 is received.

In a further step ACT-013, the request is signed, exclusively in response to the successful authentication of the user 2 in the previous step, in the present case with a digital access key. This digital access key is a valid digital access key for the motor vehicle, as shown in FIG. 1, to which the service request is directed. The digital access key may be a digital access key of a person having the right of disposal, such as an owner or proprietor, and/or a digital access key of an administrator of the motor vehicle.

In a further step ACT-014, the signature is provided from the secure element 23 back to the operating system 22.

In a further step ACT-015, a service management request is compiled from the service management request data and the signature.

In a further step ACT-016, the compiled service management request is provided from the operating system 22 back to the application 21.

In a further step ACT-017, the previously received service management request is provided from the application 21 to the key-sharing service module 31 of the remote computing device 3.

In a further step ACT-018, the request is checked, to determine whether a session between the user terminal 20 and the remote computing device 3 is valid.

In a further step ACT-019, the service management request is verified.

In a further step ACT-020, the service identifier is stored or saved in the key-sharing service module 31 of the remote computing device 3.

In a further step ACT-021, the success of the actions carried out in the remote computing device 3 is reported back to the application 21 and, in a further step ACT-022, this success and the service status as active together with service details are output on the user terminal 20 or provided to the user 2.

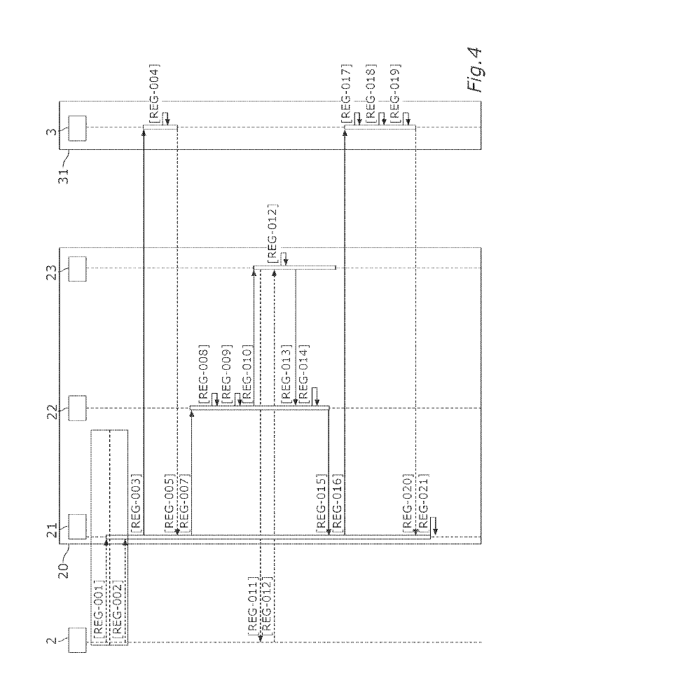

FIG. 4 shows a further flowchart of one exemplary embodiment of a method for generating key generation information for a digital access key for a motor vehicle 1. These steps shown in this FIG. 4 follow in particular the steps shown above in FIG. 3 or the steps according to FIG. 3 have been successfully run through at least once before. The steps shown here in FIG. 4 relate to registration of a user, in particular a third party, for a certain service. These steps are similar to the steps described previously in connection with FIG. 3 or are predominantly identical in content.

In a first step REG-001 of the method section shown here, a request from the user 2 to register for a service is received in the user terminal 20. In this case, the user can thereby register for the service once, whereby all user terminals of the user are enabled for this purpose.

The following three steps REG-002 to REG-008 essentially correspond to steps ACT-002 to ACT-008 described above.

In a further step REG-002, a request to request participation of the user in a service is provided from the application 21 to the key-sharing service module 31.

This request includes the service identification information as well as optionally further information such as parameters.

In a further step REG-003, service participation parameters are compiled in the key-sharing service module 31 for the request and, in a further step REG-004, these service participation parameters are provided back to the application 21.

In a further step REG-005, service participation details are displayed in the application 21 on the user terminal 20 for the user 2 and, in a further step ACT-006, a user input that confirms or enables the participation in this service is received from the user 2. These two steps are also optional.

In a further step REG-007, a signing request to sign the previously received service participation parameters is provided from the application 21 to the operating system 22.

In a further step REG-008, a service identifier is calculated by the operating system 22.

In a further step REG-009, the service participation parameters are extended by the service identifier, that is to say the latter is added to the service participation parameters.

In a further step REG-010, the service participation parameters are signed by the operating system 22 and, in a further step REG-011, the service participation parameters and the signature are provided back to the application 22.

In a further step REG-012, the previously received service participation parameters and the signature are provided from the application 21 to the key-sharing service module 31 of the remote computing device 3.

In a further step REG-013, the request is checked, in particular in order to determine whether a session between the user terminal 20 and the remote computing device 3 is valid.

In a further step REG-014, the service participation parameters and the signature are verified.

In a further step REG-015, the service identifier is stored or saved in the key-sharing service module 31 of the remote computing device 3 and the state is set to active.

In a further step REG-016, the success of the actions carried out in the remote computing device 3 is reported back to the application 21 and, in a further step REG-017, this success and the service status as active together with service details are output on the user terminal 20 or provided to the user 2.

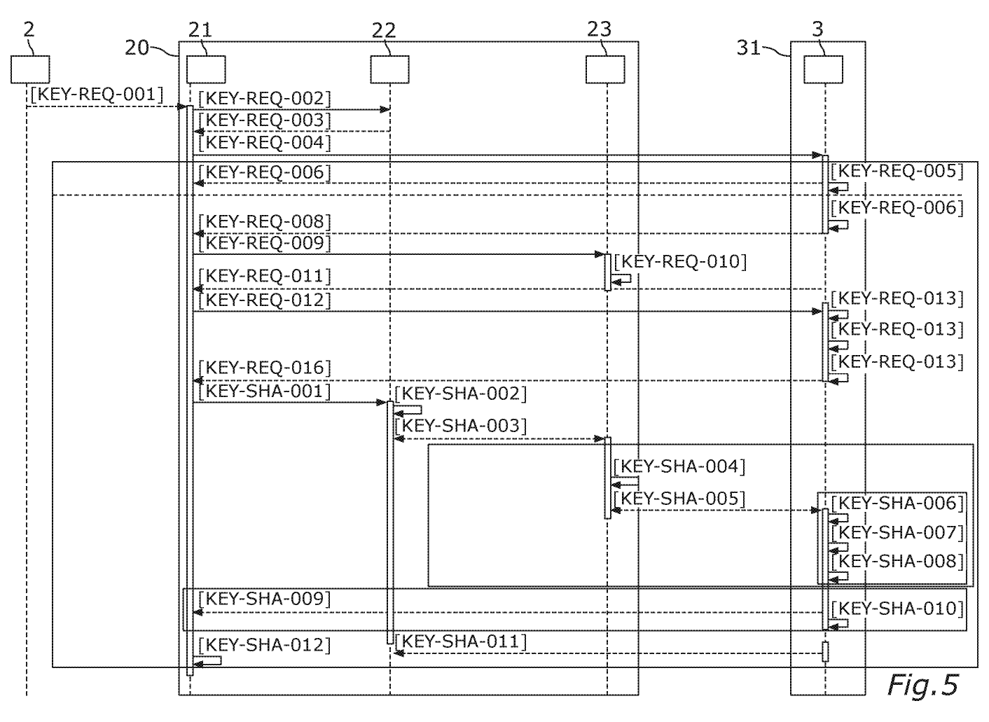

FIG. 5 shows a further flowchart of one exemplary embodiment of a method for generating key generation information for a digital access key for a motor vehicle 1. These steps shown in this FIG. 5 follow the steps shown above in FIG. 4 or the steps according to FIG. 4 have been successfully run through at least once before. The steps shown here in FIG. 5 relate to a request to generate and actual generation or sharing of a digital access key for the motor vehicle. The steps KEY-REQ-… shown here describe the processing of the request and the steps KEY-SHA-… describe the generation or sharing of the digital access key.

In a first step KEY-REQ-001 of the method section shown here, a user request from the user 2 to trigger or start key generation for a particular service is received in the application 21 of the user terminal 20. This service has unique service identification information, on the basis of which the service can be uniquely assigned or identified. In particular, the service is that service which has previously been enabled or activated as described in connection with FIG. 3.

In a further step KEY-REQ-002, a request to obtain a service identifier for the requested service is provided from the application 21 to the operating system 22, by using or providing the service identification information.

In a further step KEY-REQ-003, the service identifier for the requested service or the service identification information is provided, in response to the request, from the operating system 22 to the application 21.

In a further step KEY-REQ-004, a request to initiate or start key generation for the particular service is provided from the application 21 to the key-sharing service module 31 of the remote computing device 3. This request includes the service identification information, the previously received service identifier, as well as further information and in particular parameters for generation, such as a time frame.

In a further step KEY-REQ-005, this request is then processed in the key-sharing service module 31 of the remote computing device 3 and its validity is checked, by checking the service identifier and/or the coupling stored in the remote computing device, as described in connection with FIGS. 3 and 4.

If the check was not successful, because a coupling could not be checked or verified, an error message is output in the application 21 in a further step KEY-REQ-006 and the method is terminated at this point.

If, on the other hand, the check was successful and a coupling could be checked or verified, the method is continued with the next step KEY-REQ-007 in which generation request parameters for generating the digital access key are generated or compiled in the key-sharing service module 31. These generation request parameters include a session identification, which can also be referred to as a nonce, the service identification information, the service identifier and optionally further information or parameters, such as in particular personal data relating to the user 2.

In a further step KEY-REQ-008, these previously generated generation request parameters are provided to the application 21.

In a further step KEY-REQ-009, a request to sign the previously received generation request parameters is provided from the application 21 to the secure element 23.

In a further step KEY-REQ-010, these generation request parameters are signed by the secure element, in particular with the same key as the service management request data before, as described in connection with step ACT-013.

In a further step KEY-REQ-011, the signature is provided from the secure element to the application 21.

These three steps described above, and the signature by the secure element 23, are carried out when the user of the service is the actual owner or proprietor of the motor vehicle. If, on the other hand, the user is a third party who is authorized to do so, but is not the owner or proprietor, the following three steps are optionally alternatively carried out, and the signature is not made in the secure element 23, but instead in the operating system 22, in a secure environment of the operating system.

In a further step KEY-REQ-012, a request to sign the previously received generation request parameters is provided from the application 21 to the operating system 22.

In a further step KEY-REQ-013, these generation request parameters are signed by the operating system 22, in particular with the same key as the service management request data before, as described in connection with step ACT-013.

In a further step KEY-REQ-014, the signature is provided from the operating system 22 to the application 21.

Regardless of who signs the generation request parameters, in a further step KEY-REQ-015, the signature is then provided to the key-sharing service module 31 together with the updated generation request parameters.

In a further step KEY-REQ-016, the request is checked in the key-sharing service module 31 and the session identification is compared and the signature is checked.

If the check from the previous step was successful, key generation information is generated in the key-sharing service module 31 in a further step KEY-REQ-017. This key generation information is a reference to an Internet resource, such as a link or URL, which can be called for key generation.

In a further step KEY-REQ-018, the key generation information just generated is stored in the key-sharing service module 31 and the session is updated.

In a further step KEY-REQ-019, the generated key generation information with the service identification information is provided from the key-sharing service module 31 to the application 21.

The actual key generation or sharing now follows.

In a further step KEY-SHA-001, the key generation information with the service identification information is redeemed and the reference to the Internet resource is called.

In a further step KEY-SHA-002, in response, the key generation with the service identification information is started or initiated by the operating system 22.

In a further step KEY-SHA-003, key generation data are exchanged between the operating system 22 and the secure element 23 and key generation is initiated.

In a further step KEY-SHA-004, an endpoint certificate for the digital access key is generated in or by the secure element 23. This endpoint certificate comprises the service identification information and the service identifier derived from the service identification information from the key generation information.

In a further step KEY-SHA-005, further data are exchanged between the secure element 23 and the key-sharing service module 31 and key generation continues.

In a further step KEY-SHA-006, the coupling of the service identifier is checked in the key-sharing service module 31. To do this, the service identifier must be part of the endpoint certificate or must be included in the supplements of the certificate.

If the check or verification in step KEY-SHA-006 is not successful, in particular if the service identifier cannot be checked because it was not included in the endpoint certificate, this error is provided to the application 21 in step KEY-SHA-007 and the method is aborted in step KEY-SHA-008.

However, if the check in step KEY-SHA-006 is successful, in a further step KEY-SHA-009, confirmation information for the digital access key is provided to the operating system 22 and the key generation process is continued.

In a further, final step KEY-SHA-010, information about the generation of the digital access key and also about the service in the application 21 is provided to the user 2 and the method ends here.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Motor vehicle

2 User

20 User terminal

21 Application

22 Operating system

23 Secure element

3 Remote computing device

31 Key-sharing service module

GET-001 Method step

GET-002 Method step

GET-003 Method step

GET-004 Method step

GET-005 Method step

GET-006 Method step

GET-007 Method step

GET-008 Method step

GET-009 Method step

GET-010 Method step

ACT-001 Method step

ACT-002 Method step

ACT-003 Method step

ACT-004 Method step

ACT-005 Method step

ACT-006 Method step

ACT-007 Method step

ACT-008 Method step

ACT-009 Method step

ACT-010 Method step

ACT-011 Method step

ACT-012 Method step

ACT-013 Method step

ACT-014 Method step

ACT-015 Method step

ACT-016 Method step

ACT-017 Method step

ACT-018 Method step

ACT-019 Method step

ACT-020 Method step

ACT-021 Method step

ACT-022 Method step

REG-001 Method step

REG-002 Method step

REG-003 Method step

REG-004 Method step

REG-005 Method step

REG-006 Method step

REG-007 Method step

REG-008 Method step

REG-009 Method step

REG-010 Method step

REG-011 Method step

REG-012 Method step

REG-013 Method step

REG-014 Method step

REG-015 Method step

REG-016 Method step

REG-017 Method step

KEY-REQ-001 Method step

KEY-REQ-002 Method step

KEY-REQ-003 Method step

KEY-REQ-004 Method step

KEY-REQ-005 Method step

KEY-REQ-006 Method step

KEY-REQ-007 Method step

KEY-REQ-008 Method step

KEY-REQ-009 Method step

KEY-REQ-010 Method step

KEY-REQ-011 Method step

KEY-REQ-012 Method step

KEY-REQ-013 Method step

KEY-REQ-014 Method step

KEY-REQ-015 Method step

KEY-REQ-016 Method step

KEY-REQ-017 Method step

KEY-REQ-018 Method step

KEY-REQ-019 Method step

KEY-SHA-001 Method step

KEY-SHA-002 Method step

KEY-SHA-003 Method step

KEY-SHA-004 Method step

KEY-SHA-005 Method step

KEY-SHA-006 Method step

KEY-SHA-007 Method step

KEY-SHA-008 Method step

KEY-SHA-009 Method step

KEY-SHA-010 Method step

What is claimed is:

1. A method for generating key generation information for a digital access key for a motor vehicle, the method comprising:
providing a service request from the user terminal to a remote computing device to generate a digital access key for the motor vehicle for a predetermined service in the motor vehicle, the service request including a service identifier that identifies a service with respect to the motor vehicle and a user of the user terminal;
checking the service request in the remote computing device;
generating key generation information in the remote computing device in response to the checking;
providing the key generation information to the user terminal; and
generating a digital access key in the user terminal for the motor vehicle for the predetermined service in the motor vehicle based on the key generation information.

2. The method according to claim 1, further comprising:
generating generation request parameters including the service identifier in the remote computing device in response to the checking of the service request;
providing the generation request parameters from the remote computing device to the user terminal;
signing the generation request parameters in the user terminal;
providing the signed generation request parameters from the user terminal to the remote computing device; and
checking the signed generation request parameters in the remote computing device;
wherein the key generation information is generated in the remote computing device in response to the checking of the signed generation request parameters.

3. The method according to claim 1, wherein the step of generating the digital access key in the user terminal includes the following steps:
generating an endpoint certificate comprising the service identifier in the user terminal;
providing the endpoint certificate to the remote computing device;
checking the validity of the service identifier in the remote computing device; and
providing confirmation information for the digital access key to the user terminal and the motor vehicle in response to the checking.

4. The method according to claim 2, wherein the step of generating the digital access key in the user terminal includes the following steps:
generating an endpoint certificate comprising the service identifier in the user terminal;
providing the endpoint certificate to the remote computing device;
checking the validity of the service identifier in the remote computing device; and
providing confirmation information for the digital access key to the user terminal and the motor vehicle in response to the checking.

5. The method according to claim 1, wherein the key generation information comprises a reference to an Internet resource, and wherein the step of generating the digital access key in the user terminal includes calling the Internet resource.

6. The method according to claim 2, wherein the key generation information comprises a reference to an Internet resource, and wherein the step of generating the digital access key in the user terminal includes calling the Internet resource.

7. The method according to claim 3, wherein the key generation information comprises a reference to an Internet resource, and wherein the step of generating the digital access key in the user terminal includes calling the Internet resource.

8. The method according to claim 7, wherein the step of generating an endpoint certificate is carried out in response to calling the Internet resource.

9. The method according to claim 1, wherein the generation request parameters are signed in a secure element of the user terminal.

10. The method according to claim 2, wherein the generation request parameters are signed in a secure element of the user terminal.

11. The method according to claim 3, wherein the generation request parameters are signed in a secure element of the user terminal.

12. The method according to claim 1, wherein the generation request parameters are signed in an operating system of the user device.

13. The method according to claim 2, wherein the generation request parameters are signed in an operating system of the user device.

14. The method according to claim 3, wherein the generation request parameters are signed in an operating system of the user device.

15. The method according to claim 3, wherein the endpoint certificate is generated in a secure element of the user terminal.

16. The method according to claim 4, wherein the endpoint certificate is generated in a secure element of the user terminal.

17. An apparatus configured to generate key generation information for a digital access key for a motor vehicle, the apparatus comprising means configured to carry out a method according to claim 1.
